(19) United States
(12) Patent Application Publication
(10) Pub. No.: US 2007/0096935 A1
(43) Pub. Date: May 3, 2007

(54) Method of Updating Luminance of Light Emitting Elements according to Ambient Light Intensity Sensed by Image Capturing Units of a Portable Electronic Device

(76) Inventors: Hsin-Ta Lee, Taoyuan County (TW); Ho-Chin Lin, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/276,319

(22) Filed: Feb. 24, 2006

(30) Foreign Application Priority Data
Nov. 3, 2005 (TW) 094138581

(51) Int. Cl. G09F 9/33

(52) U.S. Cl. 340/815.42; 340/815.45

(57) ABSTRACT

A method of updating luminance of light emitting elements of a portable electronic device according to ambient light intensity sensed by image capturing units of the portable electronic device is proposed. The method includes sensing ambient light intensities using light sensors of the image capturing units, determining the luminance of the light emitting elements of the portable electronic device according to the ambient light intensities sensed by the light sensors of the image capturing units, controlling the light intensity of the light emitting elements of the portable electronic device according to the determined luminance.

### BACKGROUND OF THE INVENTION

1. Field of the Invention

The present invention relates to a method of updating luminance of light emitting elements, and more particularly, to a method of updating luminance of light emitting elements according to ambient light intensities sensed by image capturing units of a portable electronic device.

2. Description of the Prior Art

Portable electronic devices capable of taking pictures are getting more and more popular, and the function of taking pictures can be accomplished by the use of a charge coupled device (CCD) or a complementary metal oxide semiconductor (CMOS) sensor of a prior art portable electronic device. A displaying screen utilized by a prior art portable electronic device also uses more colors than before. The input keys of the prior art portable electronic devices also comprise light emitting diodes for supporting the function of taking pictures, and the function of taking pictures leads to a huge power consumption. Under a limited power supply, the efficient utilization and management of power is becoming more important also. In order to minimize the user of power, various ambient light sensors are provided for sensing ambient light intensities of a prior art portable electronic device. Then the light intensities of the backlight of the displaying screen and the light emitting diodes around the input keys of the prior art portable electronic device are updated automatically according to the sensed ambient light intensities. Therefore, although there is a limited power supply, the power supply time is lengthened, and the power consumption is also decreased by decreasing the light intensities of the backlight of the displaying screen and the light emitting diodes around the input keys of the prior art portable electronic device. However, the ambient light sensors utilized by the prior art portable electronic device increase the cost of the required hardware, require additional space, and increase the design time of the portable electronic devices.

### SUMMARY OF THE INVENTION

A method of updating luminance of light emitting elements of a portable electronic device according to ambient light intensity sensed by image capturing units of the portable electronic device comprises sensing ambient light intensities using light sensors of the image capturing units, determining the luminance of the light emitting elements of the portable electronic device according to the ambient light intensities sensed by the light sensors of the image capturing units, and controlling the light intensity of the light emitting elements of the portable electronic device according to the determined luminance of the light emitting elements of the portable electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of the reverse side of a portable electronic device utilizing the present invention method and having the function of taking pictures.

FIG. 2 is an amplified diagram of the image capturing unit of FIG. 1.

FIG. 3 is a diagram of the front side of the portable electronic device of FIG. 1.

FIG. 4 is a flowchart of utilizing the present invention method on the portable electronic device of FIG. 1.

### DETAILED DESCRIPTION

The present invention method can be applied on any electronic devices capable of taking pictures, and the function of taking pictures is accomplished by a charge coupled device or a complementary metal oxide semiconductor sensor of the electronic device. The method is an automatic luminance control procedure cooperating with the system of a portable electronic device for automatically detecting ambient light intensities. Therefore, it is not necessary to update the circuits in the electronic device or to add any hardware such as ambient light sensors to the electronic device. The light intensities of the backlight of the displaying screen and the light emitting diodes around the input keys of the portable electronic device are thus efficiently and automatically updated. However, besides running the automatic luminance control procedure of the present invention with software, there are still other ways to run the automatic luminance control procedure in the present invention. For example, running the automatic luminance control procedure with firmware or hardware cooperating with software. A portable electronic device utilizing the automatic luminance control procedure of the present invention is utilized to reach the aim of decreasing power consumption by updating the light intensities of light emitting elements and of saving the additional hardware cost needed for ambient light sensors.

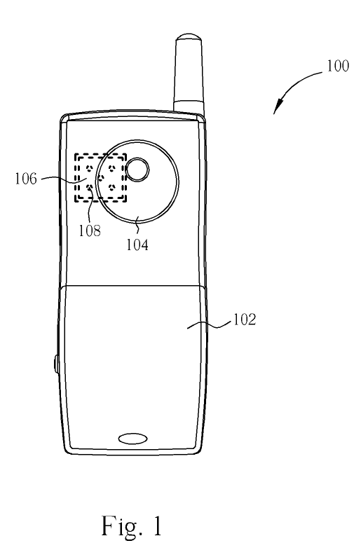

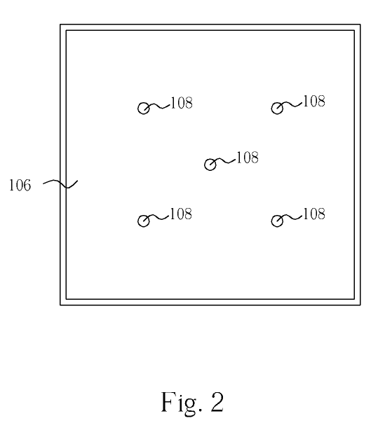

Please refer to FIG. 1, which is a diagram of the reverse side of a portable electronic device 100 utilizing the present invention method and having the function of taking pictures. As shown in FIG. 1, the portable electronic device 100 comprises a housing 102, an image capturing opening 104 disposed on the housing 102, and an image capturing unit 106 beneath the housing 102 and the image capturing opening 104. The image capturing unit 106 comprises a plurality of light sensors 108. Since the image capturing unit 106 is beneath the housing 102 and the image capturing opening 104, the image capturing unit 106 is illustrated with dotted lines as are the plurality of light sensors 108. The locations of the plurality of light sensors 108 on the image capturing unit 106 correspond to pixels. It represents that a light intensity detected by single light sensor 108 corresponds to the light intensity of a pixel. Please refer to FIG. 2, which is an amplified diagram of the image capturing unit 106 of FIG. 1. As shown in FIG. 1 and FIG. 2, the plurality of light sensors 108 are disposed on the image capturing unit 106 for sensing ambient light intensities of the image capturing opening 104. However, the number of the light sensors 108 is not limited by the embodiment shown in FIG. 2 and can be updated according to requirements.

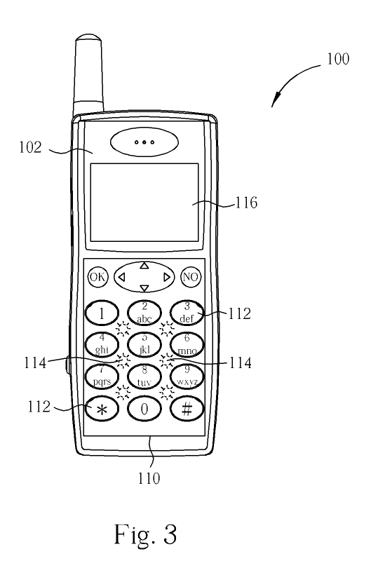

Please refer to FIG. 3, which is a diagram of the front side of the portable electronic device 100 of FIG. 1. As shown in FIG. 3, the portable electronic device 100 further comprises an input key panel 110 disposed on the housing 102, and a displaying screen 116 disposed on the housing 102 and having a backlight. The input key panel 110 comprises a plurality of input keys 112 and a plurality of light emitting diodes 114. Each of the plurality of light emitting diodes 114 corresponds to an input key 112 and is disposed near the input key 112 and beneath the input key panel 110. Since the plurality of light emitting diodes 114 are disposed beneath the input key panel 110, the plurality of light emitting diodes 114 are illustrated with dotted lines as shown in FIG. 3. The input keys 112 are generally made up of light-transmitting materials and are drawn with characters. Therefore, the drawn characters on the light-transmitting input keys 112 can be seen clearly through with the light emitted from the light emitting diodes 114. Since the characters are seen clearly, a user is able to input instructions precisely through the input key panel 110 to the portable electronic device 100. The displaying screen 116 is utilized to display messages of the portable electronic device 110. When the light intensities of the input key panel 110 and the backlight of the displaying screen 116 are darker than the ambient light intensities of the portable electronic device 100, the input key panel 110 and the displaying screen 116 cannot be seen clearly. When the light intensities of the input key panel 110 and the backlight of the displaying screen 116 are brighter than the ambient light intensities of the portable electronic device 100, unnecessary power consumption by the portable electronic device 100 is generated. Therefore, the present invention provides a method of dynamically updating the light intensities of the input key panel 110 and the backlight of the displaying screen 116 so that the light intensities of the input key panel 110 and the backlight of the displaying screen 116 are in harmony with the ambient light intensities of the portable electronic device 100. Therefore, the input key panel 110 and the displaying screen 116 are seen clearly without generating unnecessary power consumption.

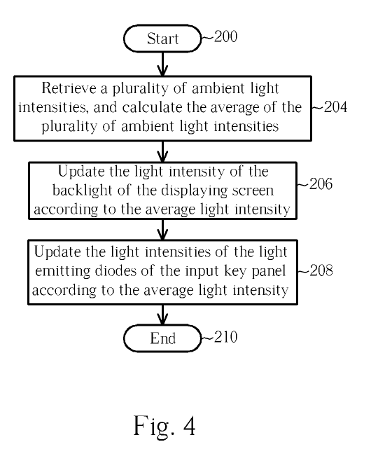

Please refer to FIG. 4, which is a flowchart of utilizing the present invention method on the portable electronic device 100 of FIG. 1. As shown in FIG. 4, the present invention method comprises:

Step 200: Starting the automatic luminance control procedure;

Step 204: Retrieving a plurality of ambient light intensities detected by the plurality of light sensors 108 of the image capturing unit 106, and calculating the average of the plurality of ambient light intensities;

Step 206: Updating the light intensity of the backlight of the displaying screen 116 of the portable electronic device 100 according to the average light intensity calculated in step 204;

Step 208: Updating the light intensities of the light emitting diodes 114 of the input key panel 110 according to the average light intensity calculated in step 204; and

Step 210: Finishing the automatic luminance control procedure.

In step 200, the automatic luminance control procedure of the portable electronic device 100 in the present invention starts. The automatic luminance control procedure is utilized to dynamically update the light intensities of the input key panel 110 and the backlight of the displaying screen 116 according to variable ambient light intensities of the portable electronic device 100. However, a user may also operate a manual luminance control procedure so that the light intensities of the backlight of the displaying screen 116 and the input key panel 110 are updated manually according to requirements of the user. Under the manual luminance control procedure, steps 204, 206, 208, and 210 do not need to be performed.

In step 204, the ambient light intensities around the image capturing opening 104 are detected using the plurality of light sensors 108 of the image capturing unit 106. Therefore, the detected ambient light intensities are regarded as standards of updating the light intensities of the backlight of the displaying screen 116 and the input key panel 110. The average of the detected ambient light intensities is regarded as a reference ambient light intensity of the portable electronic device 100 for running steps 206 and 208.

In step 206, the reference ambient light intensity retrieved in step 204 is utilized to update the light intensity of the backlight of the displaying screen 116 of the portable electronic device 100 so that the light intensity of the backlight of the displaying screen 116 is in harmony with the ambient light intensities of the portable electronic device 100. Therefore, the messages shown on the displaying screen 116 are clearly seen through the appropriate light intensity of the backlight of the displaying screen 116. Unnecessary power consumption by the displaying screen 116 is also prevented through the use of the appropriate light intensity of the backlight of the displaying screen 116.

In step 208, the light intensities of the light emitting diodes 114 of the input key panel 110 are updated according to the reference ambient light intensity retrieved in step 204 also. Therefore, the light intensities of the light emitting diodes 114 of the input key panel 110 are in harmony with the ambient light intensities of the portable electronic device 100. Thus, the user will not push the wrong keys due to dark light intensities of the input key panel 110. The power consumption of the light emitting diodes 114 is also prevented through the appropriate light intensities of the light emitting diodes 114.

The order of running steps 206 and 208 is not limited to the order shown in FIG. 4. Therefore, steps 206 and 208 may also be run in an order other than the order of FIG. 4.

In step 210, the automatic luminance control procedure is finished. Further instructions from the portable electronic device 100 are also waited for continuously for dynamically updating the light intensities of the light emitting diodes 114 of the input key panel 110 and the backlight of the displaying screen 116 according to the ambient light intensities of the portable electronic device 100. Therefore, the light intensities of the light emitting diodes 114 of the input key panel 110 and the backlight of the displaying screen 116 are in harmony with the ambient light intensities of the portable electronic device 100 continuously.

The present invention provides a method of updating the light intensities of light emitting elements according to the ambient light intensities sensed by the image capturing unit of a portable electronic device. Therefore, the light intensities of the backlight of the displaying screen and the light emitting diodes of the key input panel are dynamically updated and are in harmony with the variable ambient light intensities of the portable electronic device. Moreover, the characters on the input keys of the input key panel and the messages on the displaying screen are clearly seen since the light intensities of the light emitting diodes of the input key panel and the backlight of the displaying screen are not darker than the ambient light intensities of the portable electronic device. Unnecessary power consumption by the light emitting diodes of the input key panel and the backlight of the displaying screen is also prevented since the light intensities of the light emitting diodes of the input key panel and the backlight of the displaying screen are not much brighter than the ambient light intensities of the portable electronic device. Furthermore, since the automatic luminance control procedure of the present invention is run by using software installed on the portable electronic device in the present invention, the aim of appropriately controlling the luminance of the light emitting elements is reached by updating the software installed on a prior art portable electronic device or by using hardware and firmware capable of running the automatic luminance control procedure without using the prior art ambient light sensors. Therefore, the portable electronic device of the present invention can be made smaller than the prior art portable electronic devices by getting rid of the prior art ambient light sensors. The practicability of the portable electronic device is thus increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of updating luminance of light emitting elements of a portable electronic device according to ambient light intensity sensed by image capturing units of the portable electronic device, the method comprising:
(a) sensing ambient light intensities using light sensors of the image capturing units;
(b) determining the luminance of the light emitting elements of the portable electronic device according to the ambient light intensities sensed by the light sensors of the image capturing units; and
(c) controlling the light intensity of the light emitting elements of the portable electronic device according to the luminance determined in step (b).

2. The method of claim 1 wherein step (b) comprises determining luminance of a backlight of a displaying screen of the portable electronic device according to the ambient light intensities sensed by the light sensors of the image capturing device, and step (c) comprises controlling the light intensity of the backlight according to the luminance determined in step (b).

3. The method of claim 1 wherein step (b) comprises determining luminance of light emitting diodes (LED) around input keys of the portable electronic device according to the ambient light intensities sensed by the light sensors of the image capturing device, and step (c) comprises controlling the light intensity of the light emitting diodes according to the luminance determined in step (b).

4. The method of claim 1 wherein step (b) comprises determining luminance of the light emitting elements of the portable electronic device according to an average of the light intensities sensed by a plurality of light sensing elements of the light sensors of the image capturing unit.
